(19) United States
(12) Patent Application Publication
(10) Pub. No.: US 2019/0111987 A1
(43) Pub. Date: Apr. 18, 2019

(54) TWO WHEEL GOLF CART WITH BAG HOLDER KICKSTAND

(71) Applicant: VanDamia & Moore Distributors LLC, Wattsburg, PA (US)

(72) Inventors: Eric VanDamia, Wattsburg, PA (US); Timothy A. Moore, North East, PA (US)

(21) Appl. No.: 15/875,979

(22) Filed: Jan. 19, 2018

Related U.S. Application Data
(60) Provisional application No. 62/573,482, filed on Oct. 17, 2017.

(51) Int. Cl. B62J 11/00; B62K 21/26; B62K 21/02; B62K 11/02; B62J 23/00

(52) U.S. Cl. CPC B62J 11/00; B62K 21/26; B62K 21/02; B62K 11/02; B60Y 2200/86; B62K 2202/00; B62K 2204/00; B60Y 2200/126; B62J 23/00

(57) ABSTRACT

A two-wheeled mobility system having a frame with a first and second end and a deck extending therebetween. A handle portion is pivotably coupled with the first end of the frame. A wheel is coupled with the handle portion such that relative movement of the handle correspondingly pivots the first wheel. A second wheel is coupled with the second end of the frame and is rotationally movable relative to the frame. A bracket assembly is attachable to the frame and includes a first bracket for mounting to the frame at about the second end of the frame. A stand is connected to the first bracket and extends radially outward from the first bracket at an angle of from about 20 degrees to about 35 degrees. The stand may be used as a kickstand to support the two wheeled mobility system from falling on the ground when leaned over.

### CROSS-REFERENCE TO RELATED APPLICATIONS

This application claims priority to U.S. Provisional Patent Application Ser. No. 62/573,482, filed Oct. 17, 2017, the disclosure of which is hereby expressly incorporated by reference herein in its entirety.

### TECHNICAL FIELD

Embodiments of the technology relate, in general, to mobility technology, and in particular to two wheel carts.

### SUMMARY OF THE INVENTION

A two-wheeled mobility system is described having a frame, the frame having a first end and a second end and a deck extending from the first end of the frame to the second end of the frame. The deck is from about 1.5 feet to about 3.5 feet in length. A handle portion of the two wheeled mobility system has a first grip portion and a second grip portion, wherein the handle portion is pivotably coupled with the first end of the frame. A first wheel is coupled with the handle portion such that relative movement of the handle correspondingly pivots the first wheel relative to the frame. The first wheel is rotationally movable relative to the frame. A second wheel is coupled with the second end of the frame and rotationally movable relative to the frame.

A motor is coupled with the frame and operably configured to drive at least one of the first wheel or the second wheel A bracket assembly is attachable to the frame and includes a first bracket for mounting the bracket system to the frame at about the second end of the frame. A stand is connected to the first bracket and extends radially outward from the first bracket at an angle of from about 20 degrees to about 35 degrees. The stand may be used as a kickstand to support the two wheeled mobility system from falling on the ground when leaned over.

The stand may be removably attachable from the first bracket. The bracket assembly may include a cooler that is mountable to the first bracket. The cooler may be removably attachable from the first bracket, and may be mounted on the opposite side of the wheeled mobility system from the stand to provide better balance. The stand may extend from the first bracket to a distance off the ground wherein the ratio of the distance off the ground divided by the rear wheel's radius is about 0.9 when the two wheeled mobility system is vertical or perpendicular with respect to the plane of the ground. The bracket assembly may include a supply box mounted on the opposite side of the frame from the stand. The supply box may be removably attachable to the first bracket. The stand may include a skid plate on the bottom that contacts the ground when the wheeled mobility system is leaned over, wherein the skid plate has a forward edge having a radius of curvature of about 0.75 inches to about 2 inches. The radius is useful to protect the ground when riding the mobility system, and also reduce the effect to the rider of the stand contacting the ground when in motion.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

### BRIEF DESCRIPTION OF THE DRAWINGS

The present disclosure will be more readily understood from a detailed description of some example embodiments taken in conjunction with the following figures:

FIG. 1 is a side perspective view of a two-wheeled golf cart with a golf bag holder and integrated kickstand according to one embodiment.

FIG. 2 is a rear perspective view of a two-wheeled golf cart with a gun rack holder and integrated kickstand.

FIG. 3 is a side perspective view of the golf bag holder shown in FIG. 1 with the golf bag removed.

FIG. 4 is a side perspective view of the kickstand and holder bracket system.

FIG. 5 is a rear perspective view of the kickstand and holder bracket system.

FIG. 6 is a side view of the bottom portion of the kickstand and holder bracket system as viewed from the frame side of the two-wheeled golf cart.

FIG. 7 is a perspective bottom view of the top portion of the kickstand and holder bracket system at the cooler holder and seat mounting region.

FIG. 8 is a perspective bottom view of the top portion of the kickstand and holder bracket system at the cooler holder and seat mounting region.

### DETAILED DESCRIPTION

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Described herein are example embodiments of apparatuses, systems, and methods for providing mobility to one or two people while simultaneously transporting equipment fort those people, typically in a sporting environment. In one example embodiment, a two-wheeled scooter with an attached golf bag bracket is provided. In some embodiments, the bracket may further support a cooler. In some embodiments, the bracket/kickstand device may support one or more guns, clay targets, and/or a box of ammunition. The bracket provides for an integrated kickstand to the scooter such that the operator does not need to raise or lower a kickstand to keep the scooter upright when the operator is not on the scooter.

The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Example embodiments described herein can provide individual mobility to a golfer on a golf course, and further carry the golfer's equipment and refreshment needs throughout the golf game. For example, a golf foursome may each have an individual scooter to transport them and their equipment during a golf game. Additionally, or alternatively, a sporting clays shooter may transport the shooter, one or more guns, clay targets, and/or ammunition through a sporting clays course.

Traditional golf carts support two to four people and often provide mounts for golf bags. A problem with four-wheeled carts is that after the initial tee-off, the players golf balls may be widely separated on the playing field, making the players either drive together to all the ball locations, or forcing some players to leave the golf cart, take their bag, and head off from the other players. The two-wheeled scooter with an attached golf bag bracket provides for each player to have their own mobility system with integrated bag carrying capability. In order to minimize the size, weight, and complexity of the mobility system, the number of wheels is reduced from four to two, however this leads to an inherent stability problem with the tendency of a two-wheeled system falling over if not provided with a support, such as a kickstand.

Providing a kickstand can raise at least two problematic issues. First, the traditional stand must be manually extended and retracted or must include a costly sensing system that senses when the operator intends to park the scooter. This is cumbersome and annoying to the operator. Further if the extended kickstand is forgotten and left extended, it may cause the operator to crash when turning as the operator leans into the turn. In addition, the golf bag may be heavy and poorly balanced with respect to the kickstand, causing the scooter to fall over even when the kickstand is extended. Also, when golfing or using the scooter in grassy or soil environments, the kickstand may dig into the soil as the weight of the scooter and bag rest on the kickstand, causing tip over as the stand sinks into the soil.

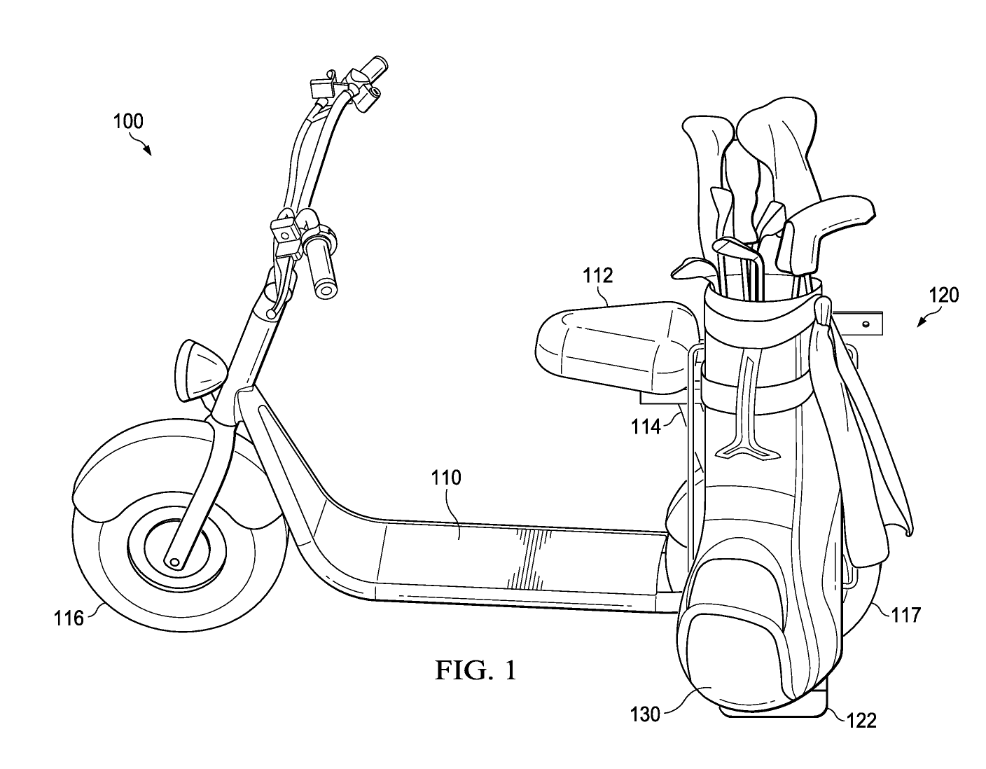

Referring now to FIG. 1 a side view of a two-wheeled golf cart with a golf bag holder and integrated kickstand is illustrated. A great deal of experimentation and development has led to the development of a two-wheeled cart with an integrated bag holder and kickstand that provides for easy, simple and sturdy mobility of an operator who frequently gets off and on the cart as they perform tasks. This is helpful when golfing or sporting clays shooting, for example, but could also be useful by construction crews or other people who need to move equipment frequently in soft soil environments. For example, a surveyor may need to move their survey tripod throughout a survey site or a farmer may need to move fence repair equipment along a fence line.

In FIG. 1, a mobility system 100 is illustrated as a two-wheeled golf cart 110 with an integrated bracket system 120. The bracket system 120 may be attached to the two-wheeled golf cart 110 near the location that a seat 112 is attached to a frame 114 of the two-wheeled golf cart 110. The height of the top of the seat 112 may be about 29 inches, the height (diameter) of wheels 116, 117 may be about 16 inches and the height of the bracket system 120 may be about 34 inches above ground level at the topmost portion when the two-wheeled golf cart 110 is parked. When the two-wheeled golf cart 110 is oriented vertically, at a 90 degree angle to the ground, (e.g. the flat normal riding position) the bottom of a skid plate 122 at the bottom of the bracket system 120 may be about 5.5 inches above the ground at its lowest point (closest to the wheel) and may be about 7.5 inches above the ground at the bottom most point farthest from the wheel. This provides for about a 20 to 30 degree lean angle of the two-wheeled golf cart 110 as it is being ridden before the skid plate 122 of the bracket system 120 rubs the ground.

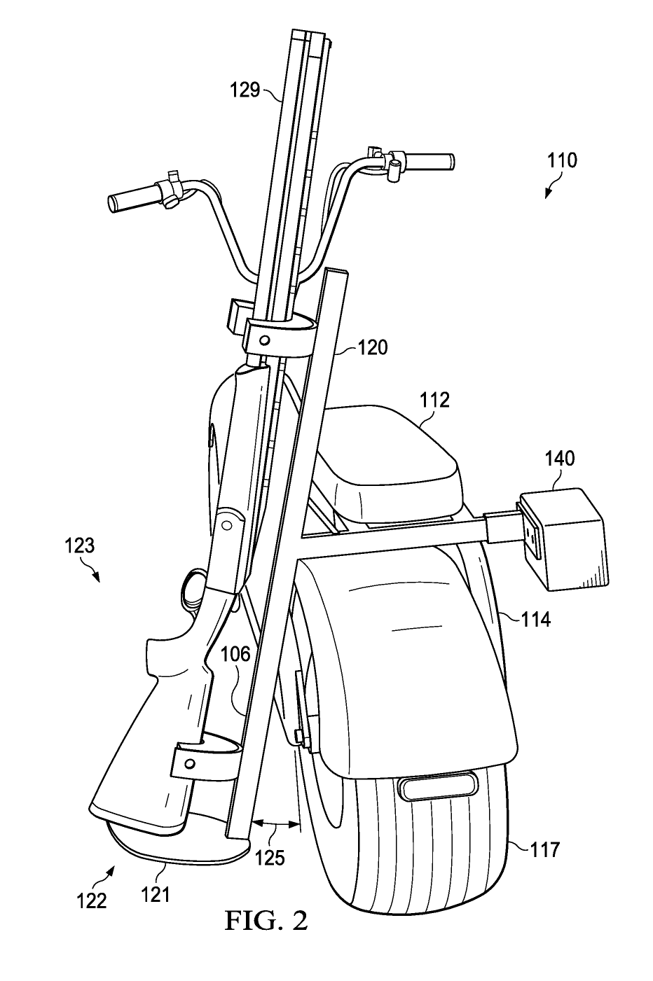

FIG. 2 is a rear view of the two-wheeled golf cart 110 with a gun rack holder 123 version of the integrated holder and kickstand 124. In FIG. 2, a gun rack holder 123 is illustrated holding a gun 129 on a bottom plate 121 of the bracket system 120. The integrated holder and kickstand 124 and/or the gun rack holder 123 has a vertical axis that is positioned at an angle 125 relative to the vertical axis of the two-wheeled golf cart 110. The angle 125 is between about 15 degrees and about 40 degrees and is preferably about 20 to 30 degrees. It is understood that when reference is made to integrated holder and kickstand 124 and/or golf bag 130, that gun rack holder 123 and/or gun 129 or other tool or object are equivalent with respect to descriptions of the aspects being described.

The angle 125 provides multiple functions. First angle 125 provides for the integrated holder and kickstand 124 and golf bag 130 to be near vertical when the mobility system 100 is parked and resting on the bracket system 120. When parking, the operator leans the mobility system 100 over until the skid plate 122 touches the ground and supports the mobility system 100, stopping it from tipping over. Leaning over the mobility system 100 brings the golf bag 130 closer to perpendicular from the ground when the mobility system 100 is parked, providing for easy access to the golf clubs in the golf bag 130. Another purpose for the angle is to keep the golf bag 130 up and off the ground when the mobility system 100 is moving, and keep the contents of the golf bag 130 contained. A further reason for the angle 125 is to provide for a flat touchdown of the skid plate 122 should the two-wheeled golf cart 110 be leaned over in a turn far enough to ground the skid plate 122. This stops the skid plate 122 from digging into the ground and upsetting the mobility system 100 as it is under way, and also protects the turf of the golf course from damage.

A cooler 140 may be attached to the bracket system 120 on the opposite side of the two-wheeled golf cart 110 from the gun 129 side of the bracket system 120. This allows the weight of the cooler 140 to balance the two-wheeled golf cart 110 when riding, as well as make the cooler 140 easier to access from the cooler side of the mobility system 100. It is understood that the cooler 140 may be replaced with a shelf or box to hold ammunition when the mobility system 100 is being used for sporting clays shooting, or replaced with a toolbox, or other desired objects for the task at hand when the mobility system 100 is being used for different tasks.

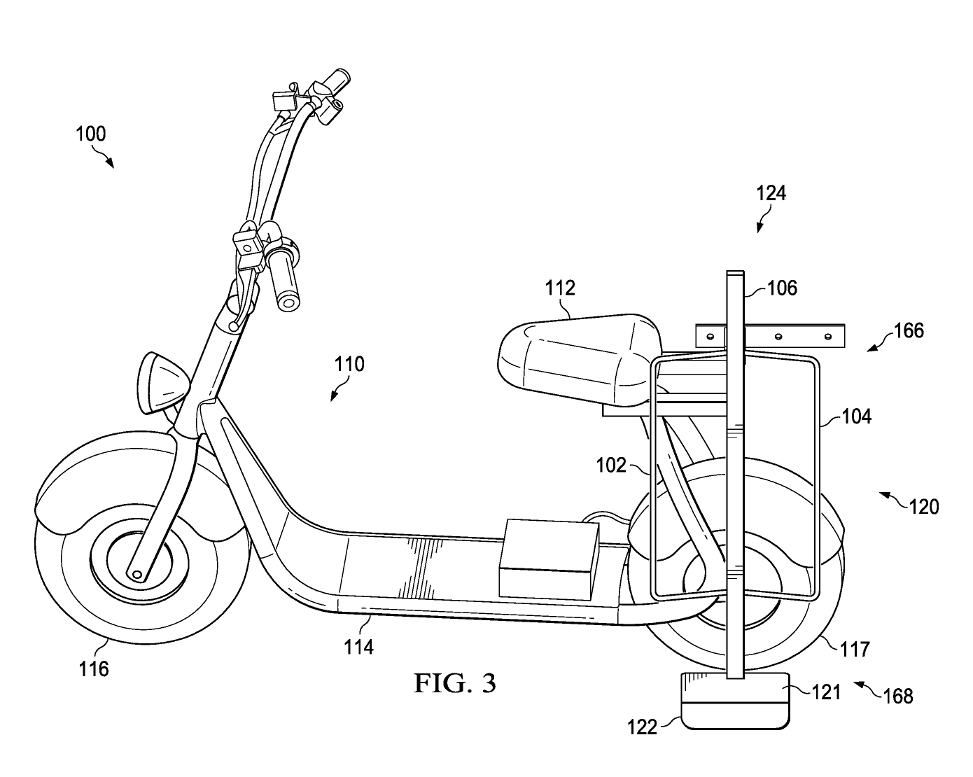

FIG. 3 depicts a more detailed view of the integrated holder and kickstand 124 of the mobility system 100 shown in FIG. 1 that may be used with the two-wheeled golf cart 110 to provide for carrying the golf bag 130 and the cooler 140. The bracket system 120 includes arms 102 and 104 that extend out from a central post 106, the arms 102, 104 extending from a top portion 166 to a bottom portion 168 of the bracket system 120.

The bracket system 120 includes an integrated holder and kickstand 124 to which the golf bag 130 (not shown in FIG. 3) may be mounted by straps or the like. The ratio of the heights of the wheel 116 and wheel 117 to the distance of the skid plate 122 off the ground and the angle of the integrated holder and kickstand 124 to the vertical axis of the two-wheeled golf cart 110 are important for a balanced mobility system 100 that is easy to operate, and easy to park. A ratio of about one for the minimum distance off the ground divided by the wheel radius has been determined to be a beneficial ratio. For example, if the minimum distance from the bottom of the skid plate to the ground may be 5.5 inches, and the wheel radius may be 6 inches, the ratio of minimum height to wheel radius would be 0.92. Ratios from 0.85 to 1.15 of the distance off the ground divided by the wheel radius are useful for a two-wheeled golf cart with an integrated holder and kickstand 124, and preferably the ratio would be about 0.9. Furthermore, the width of the wheel 116 and wheel 117 have an effect on the ground that the mobility system 100 is moving across. The wheel 116 and wheel 117 of the mobility system 100 have a width of about 6 to 10 inches and preferably a width of about 8 inches. This width keeps the wheel 116 and wheel 117 from leaving tracks on the turf of a golf course, for example, and also helps the mobility system 100 to stay afloat over sand and loose soil such as may be found in sand traps.

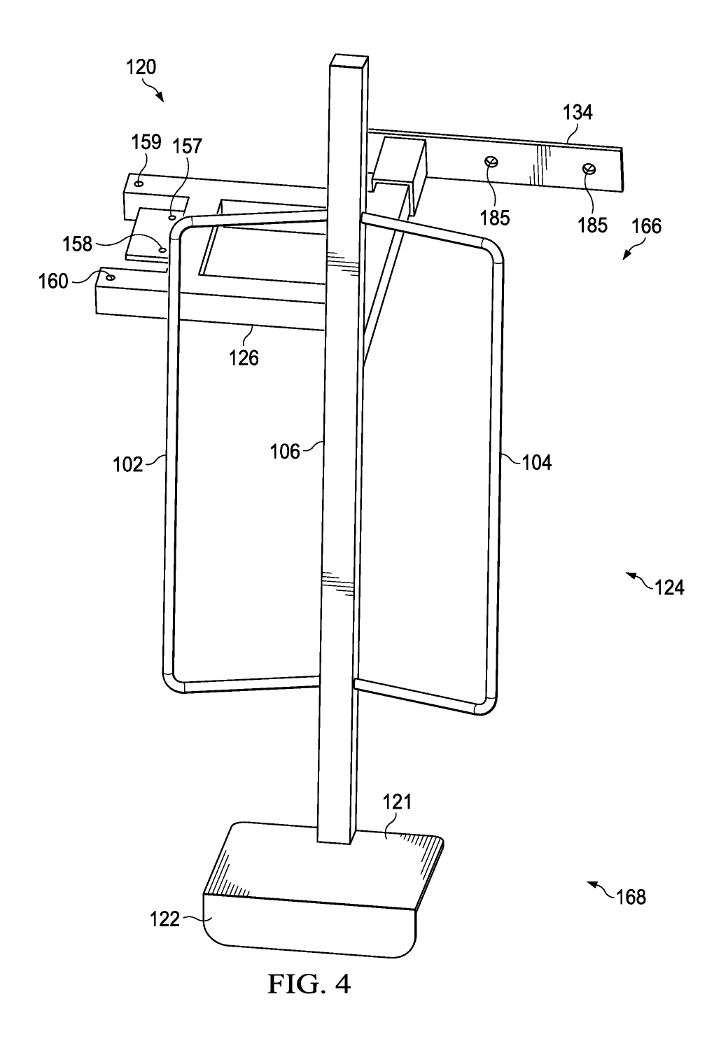

FIG. 4 is a side perspective view of the integrated holder and kickstand 124. At the bottom portion 168 of the central post 106, the bottom plate 121 may be mounted at about a 90 degree angle from the surface of the bottom plate 121 to the central post 106. The bottom plate 121 provides a surface for the golf bag 130 to rest upon so that it does not slide down off the integrated holder and kickstand 124. The skid plate 122 may be rounded and smooth at the bottom so that if the skid plate 122 does bottom out when riding, the rubbing of the skid plate 122 against the ground is not likely to cause a crash. Experimentation has shown that a minimum lean angle of about 20 degrees is needed when riding to provide for a mobility system 100 that is useful, safe, convenient and easy to use.

A mounting arm 126 extends substantially horizontally from the vertical axis of the central post 106. The mounting arm 126 includes a plurality of holes 157, 158, 159 and 160 that are located positionally on the mounting arm 126 such that they align with bolts on the two wheeled golf cart 110 in the frame 114, providing for a strong and solid mounting point. A cooler holder bracket 134 may be mounted to the mounting arm 126 on the opposite side from the integrated holder and kickstand 124. The cooler holder bracket may also include one or more bracket holes 185 that may be used to mount a cooler, and toolbox or other desired object.

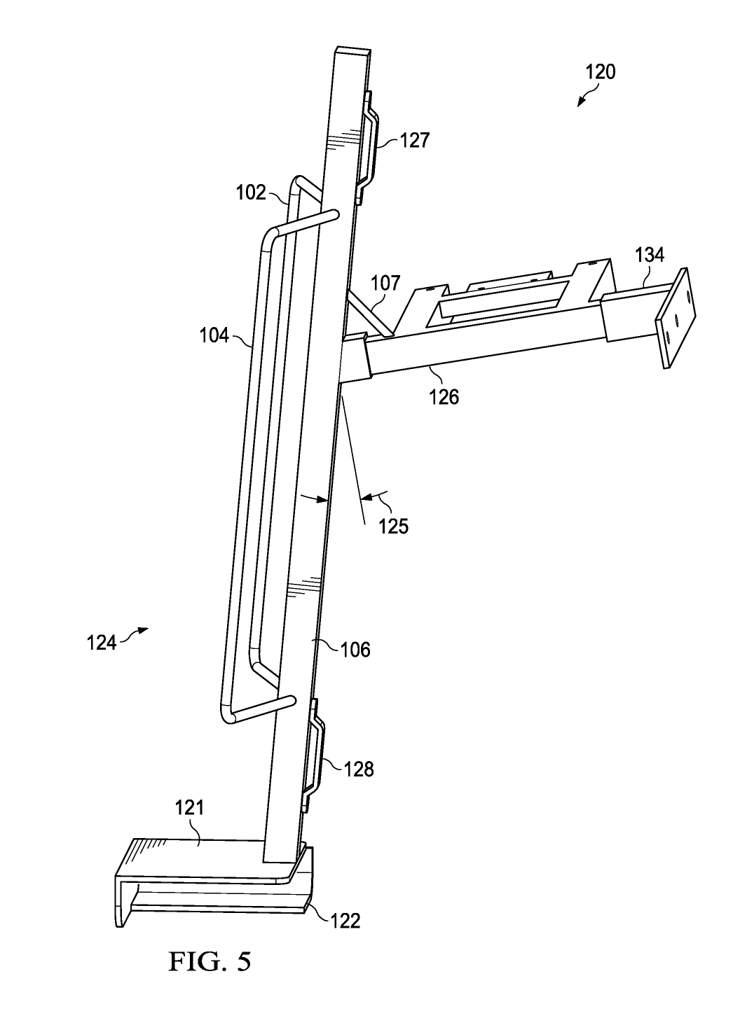

FIG. 5 is a rear perspective view of the bracket system 120 illustrating the angle 125 between the central post 106 and the mounting arm 126. The central post 106 includes strap rings 127 and 128 to provide a secure mounting location to place straps around the golf bag 130 (not shown in FIG. 5) to hold it onto the integrated holder and kickstand 124. The mounting arm 126 may be fabricated from two pieces that slip over one another to allow for quick attachment and detachment of the integrated holder and kickstand 124 from the two-wheeled golf cart 110. A brace 107 may be used to increase the stiffness of the mounting arm 126 relative to the central post 106.

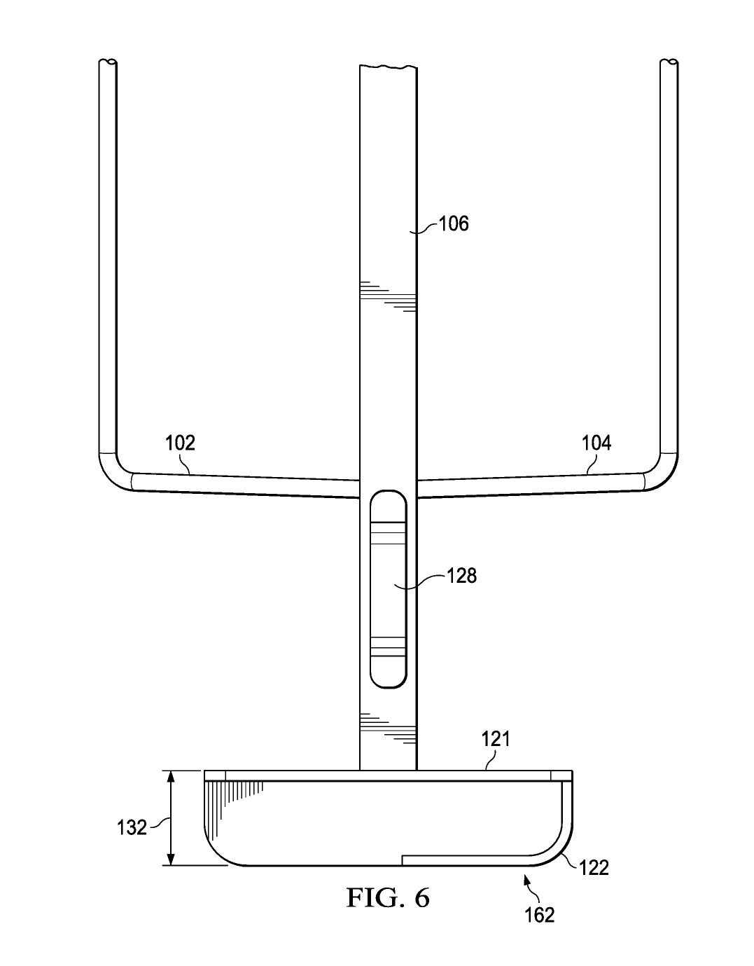

FIG. 6 is a side view of the bottom portion 168 of the integrated holder and kickstand 124. The central post 106 may be welded, for example, to the bottom plate 121. The skid plate 122 may also be welded to the bottom of the bottom plate 121 as illustrated in FIG. 6. A spacing 132 may be provided between the bottom of the bottom plate 121 and skid plate 122 such that the skid plate 122 will keep the golf bag 130 at least the spacing 132 off the ground. This protects the golf bag 130. The spacing 132 may be, for example, 1 to 5 inches and is preferably about 2 inches. The skid plate 122 is shown to be smoothly rounded at the portion facing the front of the mobility system 100, designated radius 162, so that if the skid plate 122 touches down when riding the mobility system 100 the skid plate 122 will protect the green of the golf course as well as reduce the disruption from the touch-down to the operator. Radius 162 has been determined to be an important factor in protecting the grass on a golf course, for example, and has been experimentally found to require a radius of from 0.5 to 2 inches and is preferably about a 1 inch radius.

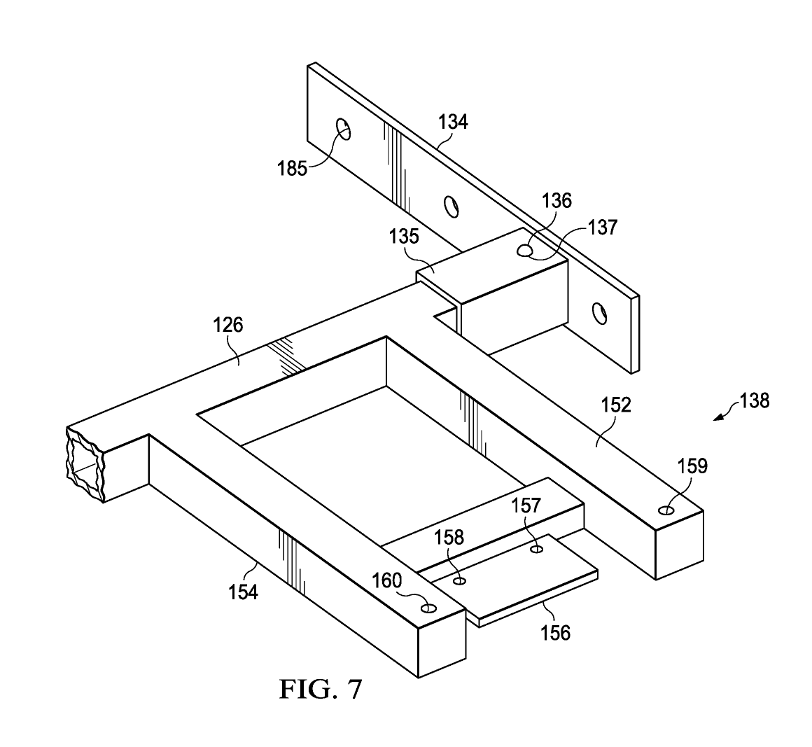

FIG. 7 is a bottom view of the top portion 166 of the bracket system 120 at the cooler holder region. The cooler holder bracket 134 may be removably connected to the bracket system 120 using a sliding member 135. The sliding member 135 may be manufactured from, for example, two square cross-section tubes that are sized such that one will slide over the other. The sliding member 135 may include a snap 136 that fits into a hole 137 as the tubes are slid together, thereby releasably holding the tubes together. The material used for the manufacture of integrated holder and kickstand 124 and bracket system 120 may be aluminum, steel, stainless steel, carbon fiber/epoxy composite or other material with sufficient stiffness and toughness to support the weight of a fully loaded golf bag as it is driven over a golf course. If steel is used, it is preferable to powder coat the steel so that rust and corrosion are reduced.

A mounting bracket 138 extends from the mounting arm 126 and includes a first mounting bracket arm 152, a second mounting bracket arm 154, a mounting bracket plate 156 having and one or more holes 157, 158. The holes 157, 158 are located to coincide with screws or bolts on the frame 114 of the two-wheeled golf cart 110 such that the bracket system 120 may be rigidly attached to the mobility system 100. One or more snap pins may be used to removably attach the integrated holder and kickstand 124 to the mounting arm 126 similarly to the cooler holder bracket 134 having sliding member 135, for example.

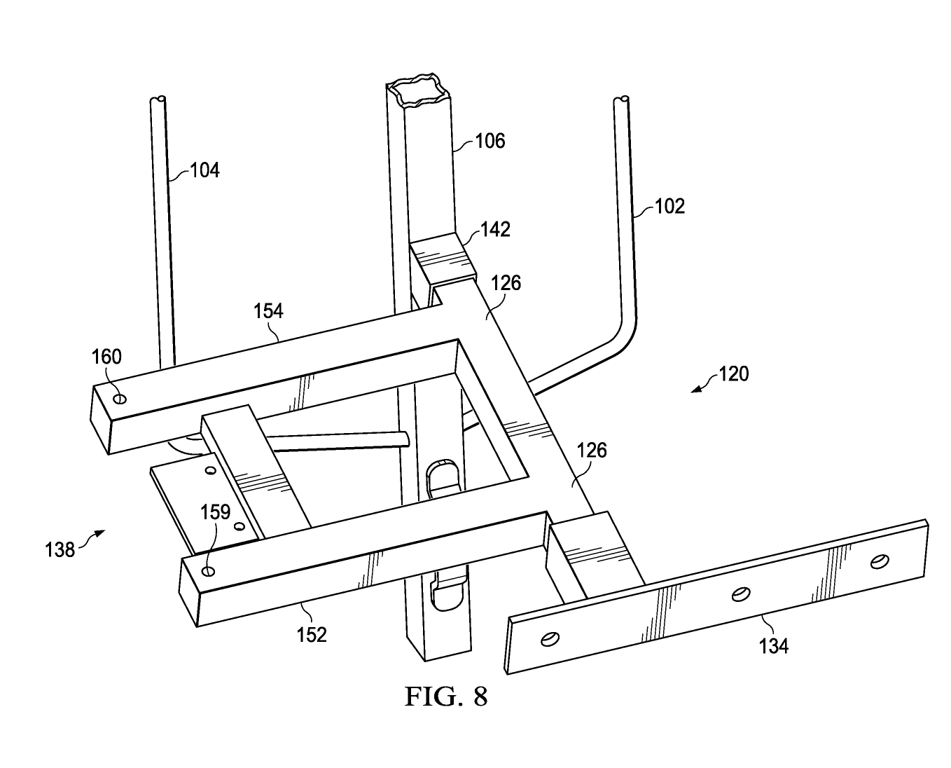

FIG. 8 is a perspective bottom view of the top portion of the integrated holder and kickstand 124 at the cooler holder region. In this view the bracket system 120 is illustrated having both a frame mount 142 and the cooler holder bracket 134 being removably coupled from the mounting arm 126 such that pieces may be easily attached, removed, and changed from one mobility system 100 to another mobility system 100. This may be beneficial for having multiple charging stations and two-wheeled golf carts 110 so that parts from the bracket system 120 may be moved from one two-wheeled golf cart 110 to another easily.

In various embodiments disclosed herein, a single component can be replaced by multiple components and multiple components can be replaced by a single component to perform a given function or functions. Except where such substitution would not be operative, such substitution is within the intended scope of the embodiments. For example, the mobility system 100 may use electric motors or may use internal combustion motors without departing from the scope of the function of the mobility system 100.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

We claim:

1. A two-wheeled mobility system comprising:
a frame, the frame having a first end and a second end and a deck extending from the first end of the frame to the second end of the frame, wherein the deck is from about 1.5 feet to about 3.5 feet in length;
a handle portion, the handle portion have a first grip portion and a second grip portion, wherein the handle portion is pivotably coupled with the first end of the frame;
a first wheel, the first wheel being coupled with the handle portion such that relative movement of the handle correspondingly pivots the first wheel relative to the frame, wherein the first wheel is rotationally movable relative to the frame;
a second wheel, the second wheel being coupled with the second end of the frame, wherein the second wheel is rotationally movable relative to the frame;
a motor, the motor being coupled with the frame, wherein the motor is operably configured to drive at least one of the first wheel or the second wheel; and
a bracket assembly, the bracket assembly being selectively attachable to the frame, the bracket assembly including;
(a) a first bracket for mounting the bracket system to the frame, wherein the first bracket is coupled to the frame at about the second end of the frame;
(b) a stand, the stand being connected to the first bracket, wherein the stand extends radially outward from the first bracket at an angle of from about 20 degrees to about 35 degrees.

2. The wheeled mobility system of claim 1, wherein the stand is removably attachable from the first bracket.

3. The wheeled mobility system of claim 1, wherein the bracket assembly includes a cooler mountable to the first bracket.

4. The wheeled mobility system of claim 3, wherein the cooler is removably attachable from the first bracket.

5. The wheeled mobility system of claim 4, wherein the cooler is mounted on the opposite side of the wheeled mobility system from the stand.

6. The wheeled mobility system of claim 1, wherein the stand extends from the first bracket to a distance off the ground wherein the ratio of the distance off the ground divided by the rear wheel's radius is about 0.9 when the two wheeled mobility system is vertical.

7. The wheeled mobility system of claim 1, wherein the bracket assembly includes a supply box mounted on the two wheeled mobility system, wherein the supply box is mounted on the opposite side of the frame from the stand.

8. The wheeled mobility system of claim 7, wherein the supply box is removably attachable to the first bracket.

9. The wheeled mobility system of claim 1, wherein the stand has a skid plate on the bottom that contacts the ground when the wheeled mobility system is leaned over, wherein the skid plate has a forward edge having a radius of curvature of about 0.75 inches to about 2 inches.

10. A wheeled mobility system comprising:
a frame having a pivot, the pivot pivotably coupling a front wheel to the frame, a handle portion, wherein the handle portion is substantially rigidly coupled with the front wheel, the frame coupling the front wheel through the pivot to a rear wheel, the frame separating the front wheel from the rear wheel by at least two feet length from an axle of the front wheel to an axle of the rear wheel, the axle of the rear wheel providing an axis of rotation of the rear wheel defining a vertical axis that is perpendicular to the axis of rotation;
a motor driving at least one of the front or rear wheel to provide forward motion over ground; and
a bracket system attachable to the frame, the bracket system having a mounting bracket that mounts the bracket system to the frame, and a substantially rigid bracket connected to the mounting bracket, the substantially rigid bracket extending from a point on the frame to the ground when the vertical axis is at least 20 degrees leaned from true vertical with respect to the ground, and wherein the rigid bracket extends from the point on the frame to at least 4 inches off the ground when the vertical axis is substantially aligned with true vertical.

11. The wheeled mobility system of claim 10, wherein the bracket system is removably attachable to the frame.

12. The wheeled mobility system of claim 10, wherein the substantially rigid bracket is removably attachable to the mounting bracket.

13. The wheeled mobility system of claim 10, wherein the substantially rigid bracket extends from the point on the frame to about a distance off the ground equal to the radius of the rear wheel when the vertical axis is substantially aligned with true vertical.

14. The wheeled mobility system of claim 10, wherein the substantially rigid bracket extends from the point on the frame to a distance off the ground wherein the ratio of the distance off the ground divided by the rear wheel's radius is from about 0.85 to 1.15 when the vertical axis is substantially aligned with true vertical.

15. The wheeled mobility system of claim 10, wherein the substantially rigid bracket extends from the point on the frame to a distance off the ground wherein the ratio of the distance off the ground divided by the rear wheel's radius is about 0.9 when the vertical axis is substantially aligned with true vertical.

16. The wheeled mobility system of claim 10, wherein the bracket system further comprises a cooler.

17. The wheeled mobility system of claim 16, wherein the cooler is removably attachable to the mounting bracket.

18. The wheeled mobility system of claim 10, wherein the bracket system further comprises a supply box mounted on the two wheeled mobility system wherein the supply box is mounted on the opposite side of the frame from the substantially rigid bracket.

19. The wheeled mobility system of claim 16, wherein the supply box is removably attachable to the mounting bracket.

20. The wheeled mobility system of claim 10, wherein the substantially rigid bracket has a skid plate on the bottom that contacts the ground when the wheeled mobility system is leaned over, wherein the skid plate has a forward edge having a radius of curvature of about 0.75 inches to about 2 inches.
